(19) United States
(12) Patent Application Publication
(10) Pub. No.: US 2016/0078468 A1
(43) Pub. Date: Mar. 17, 2016

(54) AUTOMATED SERVICE VERIFICATION SYSTEM

(71) Applicants: Linda P. Higgins, Greenwich, CT (US); H. Scott Higgins, Greenwich, CT (US)

(72) Inventors: Linda P. Higgins, Greenwich, CT (US); H. Scott Higgins, Greenwich, CT (US)

(21) Appl. No.: 14/852,080

(22) Filed: Sep. 11, 2015

Related U.S. Application Data
(60) Provisional application No. 62/049,711, filed on Sep. 12, 2014.

(51) Int. Cl. G06Q 30/02; G06Q 30/06

(52) U.S. Cl. CPC G06Q 30/0236; G06Q 30/0609

(57) ABSTRACT

Some embodiments are associated with receiving, from a remote potential member device, an electronic message comprising a request for military service verification. In addition, the request may be associated with: an indication of an affirmative attestation that the potential member, or a relative of the potential member, has served or is currently serving in the military, supplemental service information, an electronic image of the potential member's face, a name, and associated payment information (e.g., a credit card number). A validation process may then be automatically performed and a unique identifier may be assigned to the potential member. It may also be arranged for an identification card, including the name, the image of the potential member's face, and the unique identifier, to be provided to the potential member, and the potential member may now be designated as a verified member.

### CROSS-REFERENCE TO RELATED APPLICATIONS

The present application claims the benefit of U.S. Provisional Patent Application No. 62/049,711 entitled “PATENT FOR MILITARY VERIFICATION” filed Sep. 12, 2014. The entire content of that application is incorporated herein by reference.

### BACKGROUND

The invention relates generally to military service and more particularly to systems and methods to provide automated service verification.

An enterprise might want to provide a discount or other benefit to people who have served (or are currently serving) in the US military. For example, a retailer might want to give a 10% discount to customers who are veterans. As other examples, an insurance company might want to give improved benefits to veterans, a bookstore might want to offer a particular type of coupon to veterans, a travel service might want to upgrade service for veterans, etc. It can be difficult, however, for an enterprise to determine whether or not a person has served in the military. Simply trusting customers to honestly report whether or not they have serviced in the military might lead to abuse and/or dilute the benefit being provided to veterans.

Asking a person to present a governmental identification card before receiving a benefit may also have disadvantages. For example, privacy concerns might cause veterans to avoid presenting this type of information—especially during an online transaction. A third party verification service might, in some cases, look up information in a governmental database to determine if a person has served in the military. Such an approach, however, also has privacy concerns and may violate governmental rules and regulations. Moreover, use of a third party verification service by an enterprise might be costly, delay approval of a transaction, and cause unnecessary traffic over a communication network.

It may therefore be desirable to facilitate verification of military service in an efficient and accurate manner.

### BRIEF DESCRIPTION

Some embodiments are associated with receiving, from a remote potential member device, an electronic message comprising a request for military service verification. In addition, the request may be associated with: an indication of an affirmative attestation that the potential member, or a relative of the potential member, has served or is currently serving in the military, supplemental service information, an electronic image of the potential member's face, a name, and associated payment information (e.g., a credit card number). A validation process may then be automatically performed and a unique identifier may be assigned to the potential member. It may also be arranged for an identification card, including the name, the image of the potential member's face, and the unique identifier, to be provided to the potential member, and the potential member may now be designated as a verified member.

Some embodiments are associated with: means for receiving, from a remote potential member device, an electronic message comprising a request for military service verification; means for receiving, from the remote potential member device, an indication of an affirmative attestation that the potential member, or a relative of the potential member, has served or is currently serving in the military; means for receiving, from the remote potential member device, supplemental service information; means for receiving, from the remote potential member device, an electronic image of the potential member's face; means for receiving, from the remote potential member device, at least one name and credit card information; means for automatically performing a validation process on the request for military service verification, wherein the validation process does not include a look-up of the name in a service database; means for assigning a unique identifier to the potential member; means for storing information about the potential member, including the unique identifier, in a member database behind a firewall device; and means for arranging for an identification card, including the name, the image of the potential member's face, and the unique identifier, to be provided to the potential member, wherein the potential member is now designated as a verified member.

Other embodiments are associated with systems and/or computer-readable medium storing instructions to perform any of the methods described herein.

### DRAWINGS

FIG. 1 is a block diagram of a system that may be associated with any of the embodiments described herein.

FIG. 2 is a flow chart of a verification method in accordance with some embodiments.

FIG. 3 is a flow chart of a partner confirmation method in accordance with some embodiments.

FIG. 4 illustrates a web browser display in accordance with some embodiments.

FIG. 5 illustrates a tablet computer display in accordance with some embodiments.

FIG. 6 illustrates an account information display in accordance with some embodiments.

FIG. 7 illustrates a network diagram in accordance with some embodiments.

FIG. 8 illustrates a verified member identification card according to some embodiments.

FIG. 9 is an apparatus that may be provided in accordance with some embodiments.

FIG. 10 is a tabular view of a portion of a verified member database in accordance with some embodiments of the present invention.

### DETAILED DESCRIPTION

Some embodiments disclosed herein facilitate verification of military service in an efficient and accurate manner. Some embodiments are associated with systems and/or computer-readable medium that may help perform such a method.

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

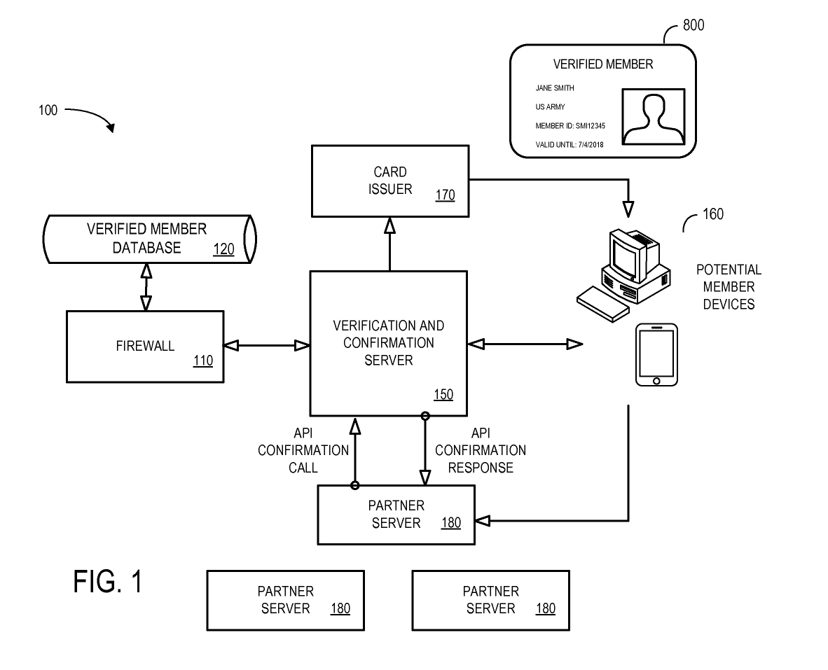

Some embodiments described herein may automatically facilitate verification of military service in an efficient and accurate manner. For example, FIG. 1 is a block diagram of a system 100 that may be associated with any of the embodiments described herein. In particular, the system 100 includes a verification and confirmation server 150 that may access a verified member database 120 located behind a “firewall” 110. As used herein, the term “firewall” may refer to, for example, any network security system that monitors and controls the incoming and outgoing network traffic based on predetermined security rules. A firewall may, for example, establish a barrier between a trusted, secure internal network and an outside network, such as the Internet, and may comprise a network firewalls or a host-based firewall.

The verified member database 120 may periodically update (e.g., on a daily or weekly basis) information about potential members who have been verified as having actually served in the US military. The verification and confirmation server 150 may also communicate with a set of potential member devices 160 that are used to exchange information. The potential member devices 160 may, for example, be used to execute a web browser, smartphone application, etc. According to some embodiments, the verification and confirmation server 150 may use a Graphical User Interface (“GUI”) to render user displays for the potential member devices 160.

The verification and confirmation server 150 and/or other devices within the system 100 might be, for example, associated with a Personal Computer (“PC”), laptop computer, smartphone, an enterprise server, a server farm, and/or a database or similar storage devices. The verification and confirmation server 150 may, according to some embodiments, be associated with a third party verification service.

According to some embodiments, an “automated” verification and confirmation server 150 may facilitate the verification and confirmation of military service. For example, the verification and confirmation server 150 may receive a verification request from a potential member operating remote client platform 160 in accordance with any of the embodiments described herein. The verification and confirmation server 150 may automatically perform a verification process on the request and, based on that process, store an indication that the member has been verified in the verified member database 120. As used herein, the term “automatically” may refer to, for example, actions that can be performed with little (or no) intervention by a human. The verification and confirmation server 150 may also transmit information to a card issuer 170 who can then print a card for the verified member and arrange for it to be delivered to him or her (e.g., via postal mail). The member may then present the card at a retailer, Point Of Sale (“POS”) device, etc. of a partner enterprise. A partner server 180 may then execute an Automated Programming Interface (“API”) call to the verification and confirmation server 150. After checking the verified member database 120, the verification and confirmation server 150 may transmit an API confirmation to response to the partner server 180 indicating the member is, in fact, verified. The partner enterprise may then arrange for the veteran to receive his or her benefit.

As used herein, devices, including those associated with the verification and confirmation server 150 and any other device described herein may exchange information via any communication network which may be one or more of a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

The verification and confirmation server 150 may store information into and/or retrieve information from the verified member database 120. The verified member database 120 might be locally stored or reside remote from the verification and confirmation server 150. As will be described further below, the verified member database 120 may be used by the verification and confirmation server 150 to facilitate interactions with users of potential member devices 160 and partner servers 180. According to some embodiments, the verification and confirmation server 150 communicates information associated with members to a remote device and/or to an automated system, such as by transmitting an electronic file to a user device, an email server, a workflow management system, etc.

Although a single verification and confirmation server 150 is shown in FIG. 1, any number of such devices may be included. Moreover, various devices described herein might be combined according to embodiments of the present invention. For example, in some embodiments, the verification and confirmation server 150 and verified member database 120 might be co-located and/or may comprise a single apparatus.

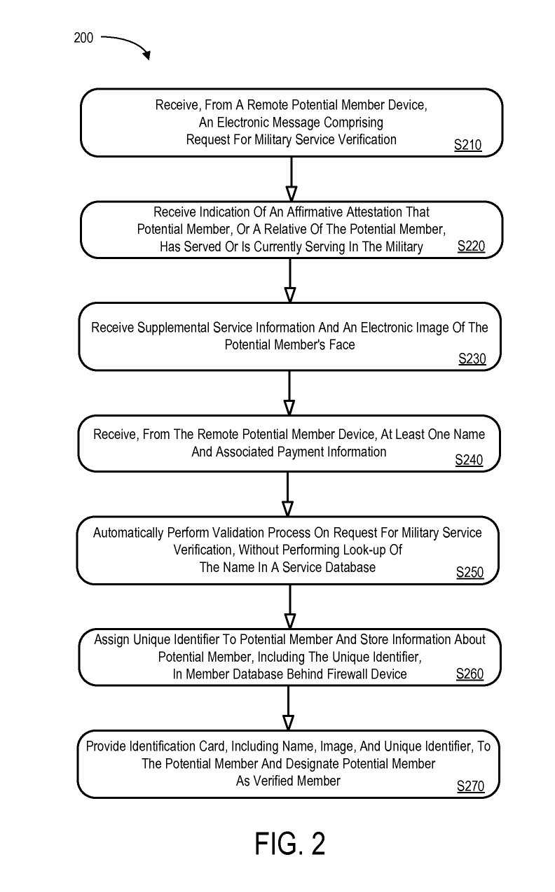

Note that the system 100 of FIG. 1 is provided only as an example, and embodiments may be associated with additional elements or components. According to some embodiments, the elements of the system 100 facilitate an automated service verification process. Consider, for example, FIG. 2 which is a flow chart of a method 200 associated with a method in accordance with some embodiments. The flow charts described herein do not imply a fixed order to the steps, and embodiments of the present invention may be practiced in any order that is practicable. Note that any of the methods described herein may be performed by hardware, software, or any combination of these approaches. For example, a non-transitory computer-readable storage medium may store thereon instructions that when executed by a machine result in performance according to any of the embodiments described herein.

At S210, the system may receive, from a remote potential member device, an electronic message comprising a request for military service verification. For example, a potential member might access a web page and seek to sign-up with a third-party service verification platform or program.

At S220, the system may receive, from the remote potential member device, an indication of an affirmative attestation that the potential member, or a relative of the potential member, has served or is currently serving in the military. Providing this type of attestation may cause people to hesitate before providing untruthful information.

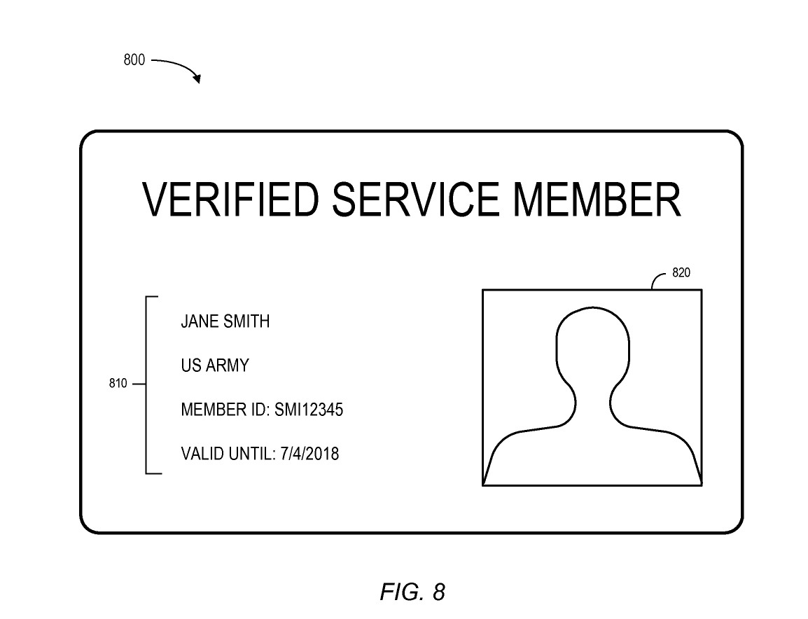

At S230, the system may receive, from the remote potential member device, supplemental service information. The supplemental service information might include, for example, service years (e.g., that the member served in the US army from 2010 through 2012 or during the Korean War), a rank title, a unit, and/or a pay grade (e.g., E1 through E9, O1 through O10, W1 through W5, or “unknown”). The supplemental service information might also include a branch of service, such as: US World War (“WW”) II Merchant Marines, US National Oceanic and Atmospheric Administration (“NOAA”) Corps, US United States Public Health Service Commissioned Corps (“PHSCC”), US Department of Defense, US Marine Corps Reserves, US Naval Reserve, US Army, US Navy, US Air Force, US Marine Corps, US Coast Guard, US Army National Guard, and/or US Army Reserve. At S230 the system may also receive, from the remote potential member device, an electronic image of the potential member's face (e.g., to be printed on a physical identification card as described with respect to FIG. 8). Providing these types of details may further cause people to hesitate before providing untruthful information.

At S240, the system may receive, from the remote potential member device, at least one name and associated payment information (e.g., a credit card number, expiration date, and billing address). According to some embodiments, the verification process might be a free service performed for veterans, but members may have the option of purchasing additional bundles of benefits (e.g., purchasing a two year membership might provide benefits greater than those offered to veterans who have been verified by have not purchased the additional bundle of benefits).

At S250, the system may automatically perform a validation process on the request for military service verification. For example, business rules or logic may be applied to determine that the supplement information is consistent (e.g., that a particular unit exists). Note that the validation process might not include a look-up of the name in a service database (e.g., a database maintained by the government for other purposes, such as Veterans Authority services). According to some embodiments, the verification process is associated with Knowledge-Based Authentication (“KBA”). In some cases, the KBA may comprise a method of authentication which seeks to prove the identity of someone accessing something, such as a service verification platform, that requires the knowledge of private information of the individual to demonstrate that the person providing the identity information is the owner of the identity.

At S260, the system may assign a unique identifier to the potential member (e.g., using an algorithm and information about the member). According to some embodiments, the unique identifier is also associated with a travel discount code (e.g., a code that may be used to obtain travel and/or lodging at a discount). Information about the potential member, including the unique identifier, may then be stored in a member database behind a firewall device.

At S270, it may be arranged for an identification card, including the name, the image of the potential member's face, and the unique identifier, to be provided to the potential member, who may now be designated as a “verified member.”

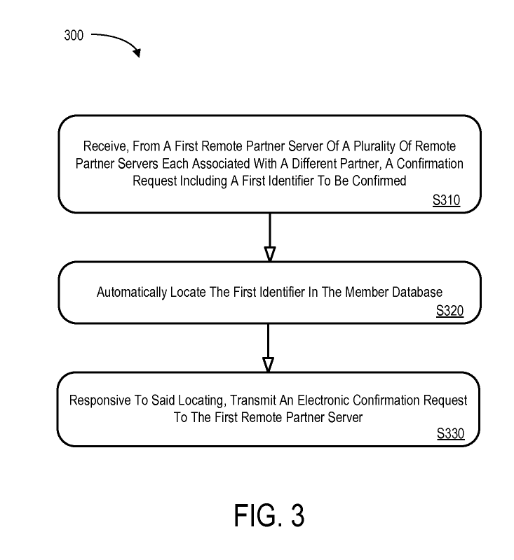

After being designated as a “verified member,” the veteran may use the identification card and/or unique code to receive benefits from partner merchants and/or other enterprises. For example, FIG. 3 is a flow chart of a partner confirmation method 300 in accordance with some embodiments. At S310, the system may receive, from a first remote partner server of a plurality of remote partner servers each associated with a different partner, a confirmation request including a first identifier to be confirmed. At S320, the system may automatically locate the first identifier in the member database. Responsive to said locating, the system may transmit at S330 an electronic confirmation request to the first remote partner server. According to some embodiments, the confirmation request is processed via an API and may be associated with a benefit bundle program. Once the member's service has been confirmed, the partner enterprise may give the member his or her benefit (e.g., a car rental upgrade).

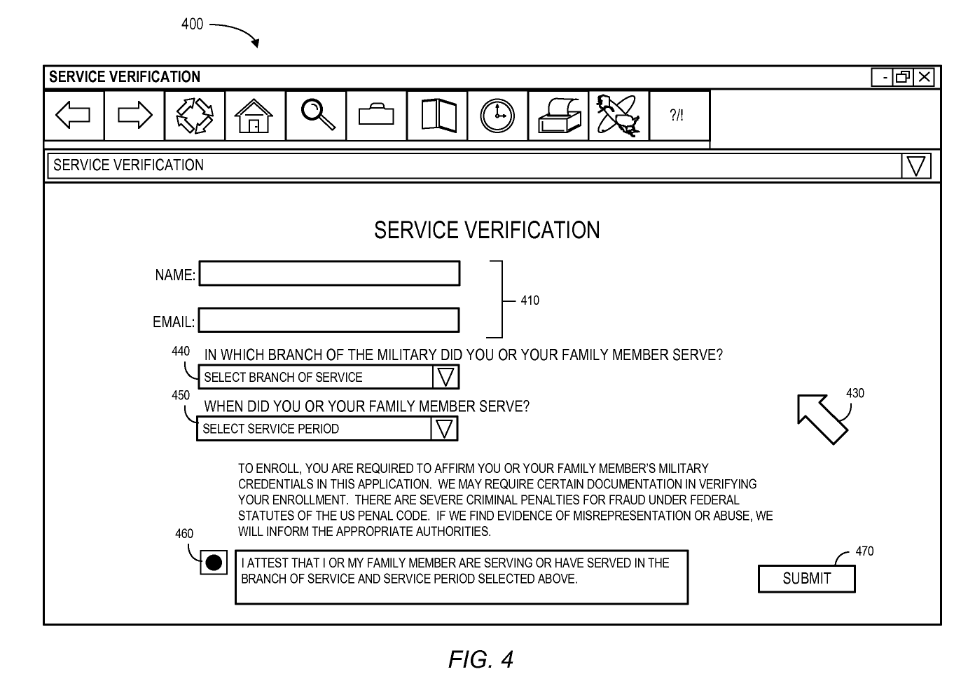

FIG. 4 illustrates a web browser display 400 in accordance with some embodiments. The display includes a member information area 410 where he or she can provide a name and email address. The user may then move a computer mouse pointer or icon 430 to select which branch of service 440 he or she served in (e.g., US Army or US Navy). Similarly, the user may select a service period when the user (or a family member of the user) served in the military. After attesting that he or she is providing truthful information via indication 460, he or she may submit the information via activation of a button icon 470.

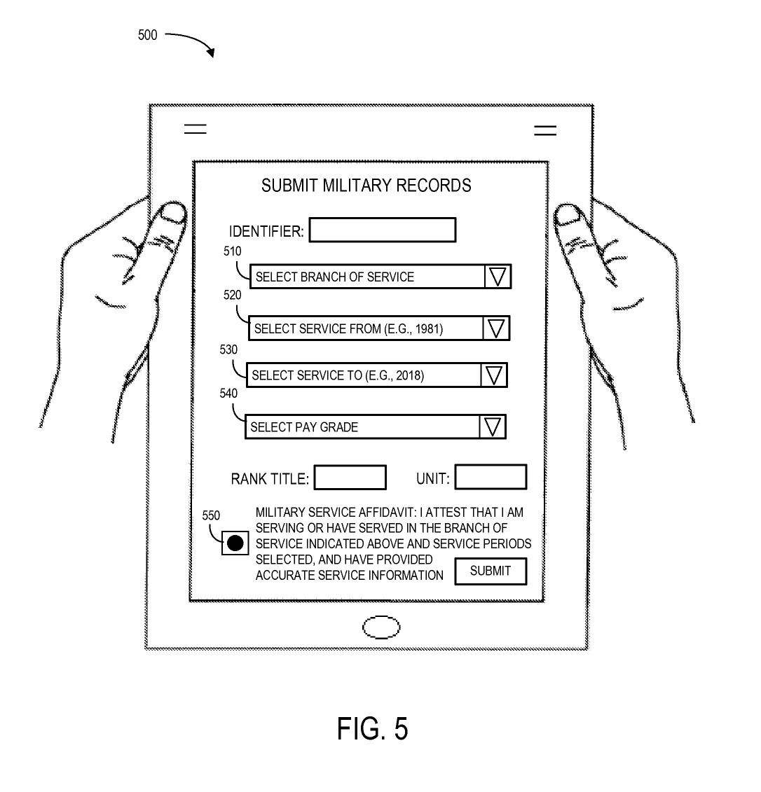

FIG. 5 illustrates a tablet computer display 500 in accordance with some embodiments. The display 500 may have a touch screen interface to let the user select: a branch of service 510, a service beginning year 520, a service ending year 530, and a pay grade 540. Note that the display 500 may also collect other information, such as a rank title and/or unit associated with his or service. After attesting that he or she is providing truthful information via indication 550, he or she may submit the information via activation of a “Submit” button.

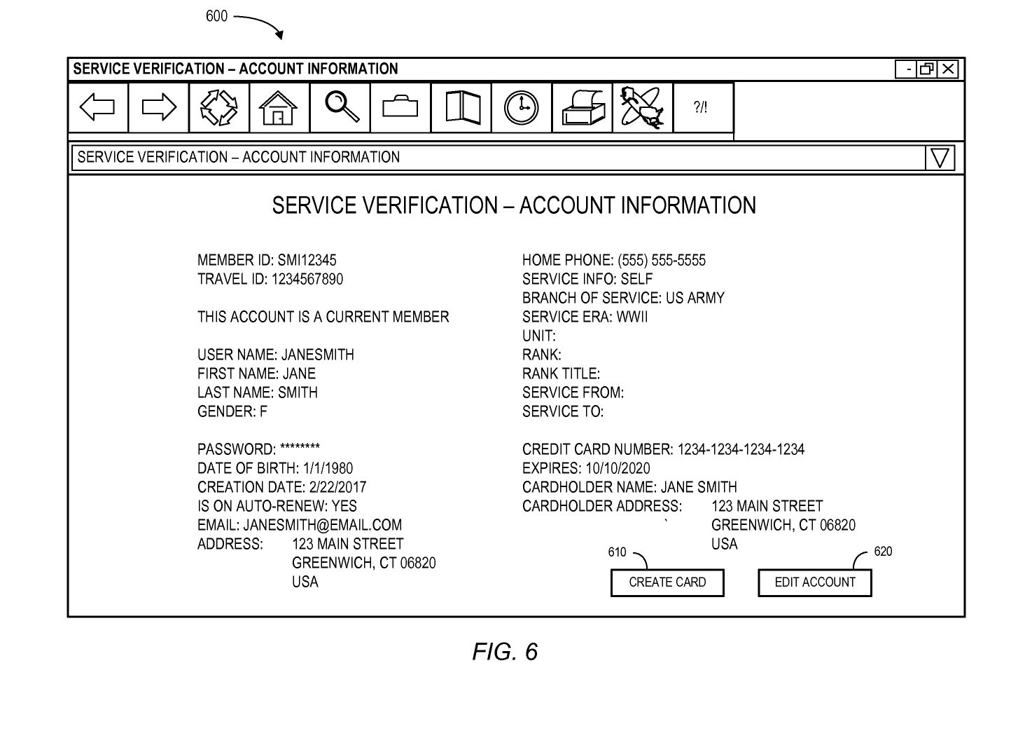

FIG. 6 illustrates an account information display 600 in accordance with some embodiments. The display 600 might be provided to, for example, a member or an administrator. The display 600 details the information associated with a member account, including, for example, a member ID, travel ID, name, gender, password, date of birth, account creation date, email address, postal address, telephone number, branch of service, service era, unit, rank, rank title, and payment information. A “Create Card” button 610 may initiate the printing of an identification card and an “Edit Account” button 620 may let a user or administrator alter the account information on the display 600.

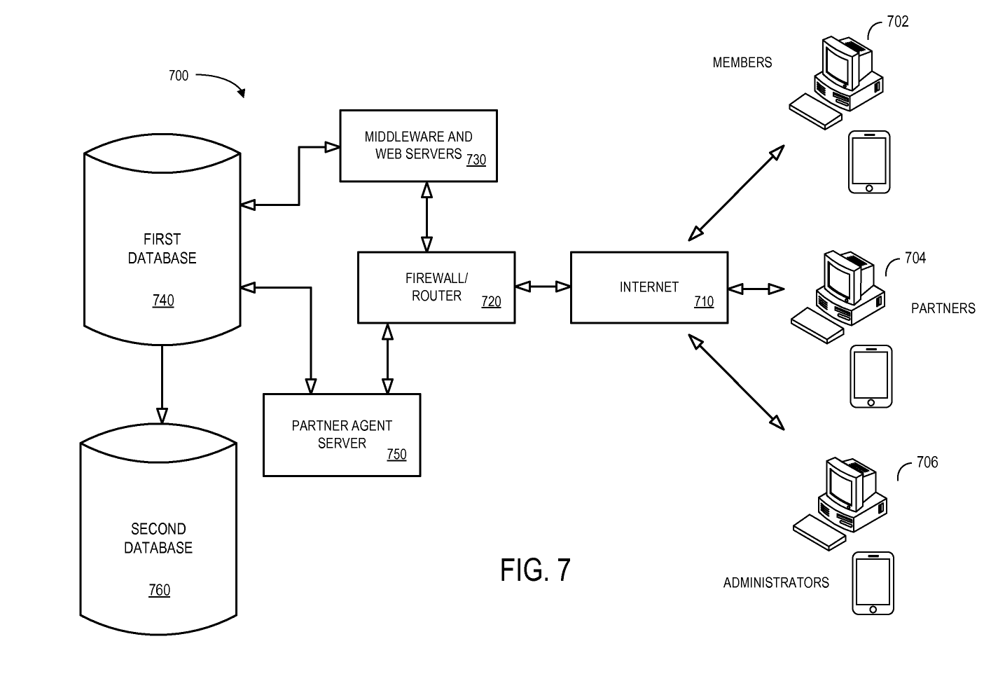

FIG. 7 illustrates a network diagram 700 in accordance with some embodiments. In particular, the network diagram 700 includes client machines associated with member and/or the public 702, partners consuming API 704, and administrators 706 (such as a main office, customer service, etc.) that access a firewall/router 720 via the Internet 710. The firewall/router 720 may connect with a first database 740 via middleware servers and/or web servers 730. The first database 740 might comprise, for example, a production database. The firewall/router 720 may also connect with the first database 740 via a partner agent server 750 (e.g., a web server). Information in the first database 740 may be copied to a second database 760 to support live backup, replicator functions, and/or On-Line Analytical Processing (“OLAP”) operations.

The network diagram 700 may be used by a partner to verify whether someone (associated with a member identifier) is, or has been, a service member. According to some embodiments, this may be performed via a member identifier ping API. The API might comprise a simple URL call with parameters (e.g., without needing HTTP POST or headers). The API might be associated with 256 bit Secure Socket Layer (“SSL”) securing to secure the URL call with a username and password. Moreover, an HTTP GET protocol may be used to implement the API. The partner may then call a URL via code and check for a 1, 2, 3 (for valid results) or a 0 (for an invalid result—that is the member has not been verified as having served in the military).

Once a partner obtains a ping API username and password, a customer member identifier entered by a customer (e.g., in a “promo code” box) can be passed via an HTTPS web call. The partner may then read the output from the URL. The API may, according to some embodiments return a 1 if the specified member identifier is a valid veteran or military member, 2 for a family member, and 3 for enrolled benefits member in the first database 740. The API will return a 0 if the member identifier cannot be found in the first database 740 or the member is no longer active in the program.

Similarly, the network diagram 700 may be used to a partner to verify whether someone (associated with a travel discount code) is, or has been, a service member. According to some embodiments, this may be performed via a member identifier ping API. The API might comprise a simple URL call with parameters (e.g., without needing HTTP POST or headers). The API might be associated with 256 bit Secure Socket Layer (“SSL”) securing to secure the URL call with a username and password. Moreover, an HTTP GET protocol may be used to implement the API. The partner may then call a URL via code and check for a 1 (for valid results) or a 0 (for an invalid result—that is the member has not been verified as having served in the military).

Once a party obtains a ping API username and password, a travel discount code entered by a customer (e.g., in a “promo code” box) can be passed via an HTTPS web call. The party may then read the output from the URL. The API may, according to some embodiments return a 1 if the specified travel discount code is a valid veteran or military member. The API will return a 0 if the travel discount code cannot be found in the first database 740 or the member is no longer active in the program.

According to some embodiments, a member may verify his or her service by providing the unique identifier to a merchant (e.g., when ordering a product online). According to some embodiments, a member may instead display a smartphone image to a merchant as a form of identification. In other cases, the member might present a physical identification card to a merchant (e.g., when or she is making a purchase at a retail store). FIG. 8 illustrates a verified member identification card 800 according to some embodiments. The card 800 includes member information 810 (name, branch of service, member identifier, and expiration date) and an image of the members face 820 (e.g., based on the electronic image file received from the member and which may be used by a merchant to make sure that the person presenting the card 800 at the POS terminal is, in fact, the person associated with the member identifier being verified). According to some embodiments, the card 800 may further include magnetic stripe card capable of storing data by modifying the magnetism of tiny iron-based magnetic particles on a band of magnetic material on the card 800. The magnetic stripe, sometimes called swipe card or magstripe, is read by swiping past a magnetic reading head. According to some embodiments, the card 800 may also contain an RFID tag, a transponder device, and/or a microchip.

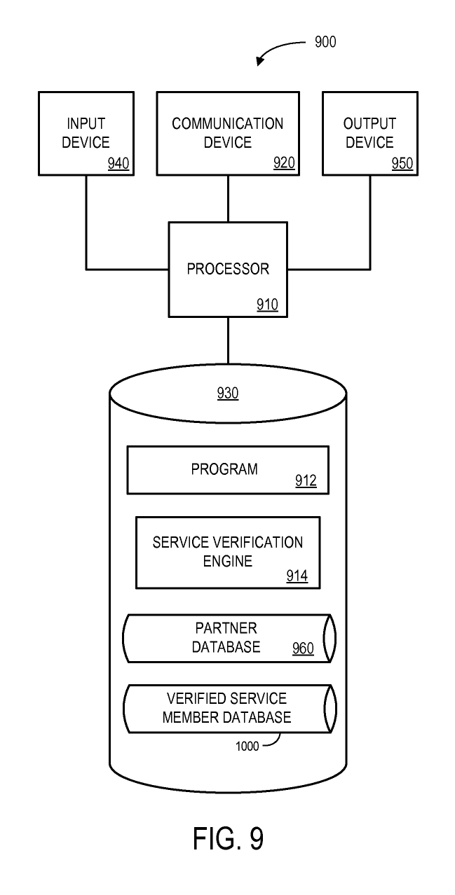

The embodiments described herein may be implemented using any number of different hardware configurations. For example, FIG. 9 illustrates an apparatus 900 that may be, for example, associated with the system 100 of FIG. 1. The apparatus 900 comprises a processor 910, such as one or more commercially available Central Processing Units (CPUs) in the form of one-chip microprocessors, coupled to a communication device 920 configured to communicate via a communication network (not shown in FIG. 9). The apparatus 900 further includes an input device 940 (e.g., a mouse and/or keyboard to enter information about business rules and logic, veteran information, etc.) and an output device 950 (e.g., a computer monitor to output status displays, reports, batches of identification cards to be generated, etc.).

The processor 910 also communicates with a storage device 930. The storage device 930 may comprise any appropriate information storage device, including combinations of magnetic storage devices (e.g., a hard disk drive), optical storage devices, mobile telephones, and/or semiconductor memory devices. The storage device 930 stores a program 912 and/or a service verification engine 914 for controlling the processor 910. The processor 910 performs instructions of the programs 912, 914, and thereby operates in accordance with any of the embodiments described herein. For example, the processor 910 might receive, from a remote potential member device, an electronic message comprising a request for military service verification. In addition, the request may be associated with: an indication of an affirmative attestation that the potential member, or a relative of the potential member, has served or is currently serving in the military, supplemental service information, an electronic image of the potential member's face, a name, and associated payment information (e.g., a credit card number). A validation process may then be automatically performed by processor 910 and a unique identifier may be assigned to the potential member. It may also be arranged for an identification card, including the name, the image of the potential member's face, and the unique identifier, to be provided to the potential member. The potential member may now be designated as a verified member.

The programs 912, 914 may be stored in a compressed, uncompiled and/or encrypted format. The programs 912, 914 may furthermore include other program elements, such as an operating system, a database management system, and/or device drivers used by the processor 910 to interface with peripheral devices.

As used herein, information may be “received” by or “transmitted” to, for example: (i) the apparatus 900 from another device; or (ii) a software application or module within the apparatus 900 from another software application, module, or any other source.

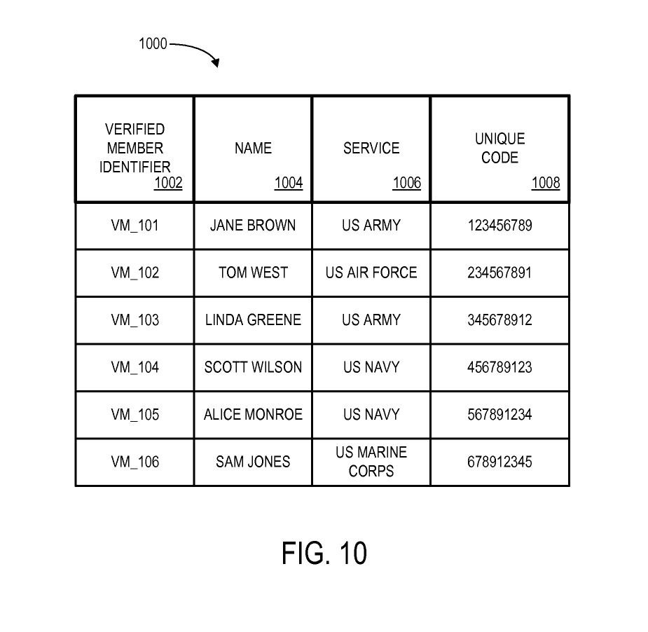

As shown in FIG. 9, the storage device 930 also stores a partner database 960 and a verified service member database 1000. One example of a verified service member database 1000 that may be used in connection with the apparatus 900 will now be described in detail with respect to FIG. 10. The illustration and accompanying descriptions of the database presented herein is exemplary, and any number of other database arrangements could be employed besides those suggested by the figures.

FIG. 10 is a tabular view of a portion of a verified service member database 1000 in accordance with some embodiments of the present invention. The table includes entries associated with members who have been verified as being service members, such as by a KBA process. The table also defines fields 1002, 1004, 1006, 1008 for each of the entries. The fields specify: a verified member identifier 1002, a name 1004, service details 1006, and a unique code 1008. The information in the database 1000 may be periodically created and updated based on information generated by a verification and confirmation server.

The verified member identifier 1002 might be a unique alphanumeric code identifying a member who has had her military service pre-verified. The name 1004 and branch of service 1006 may provide details about his or her service and the unique code 1008 may be used by the member and/or merchant to verify that he or she has been pre-verified as a veteran.

Thus, some embodiments described herein may facilitate verification of military service in an efficient and accurate manner. The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases and apparatus described herein may be split, combined, and/or handled by external systems).

Applicants have discovered that embodiments described herein may be particularly useful in connection with discounts and other benefits that might be provided to military veterans, although embodiments may be used in connection any other type of benefit or reward program.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
a member database behind a firewall device;
a communication port to receive, from a remote potential member device: (i) an electronic message comprising a request for military service verification, (ii) an indication of an affirmative attestation that the potential member, or a relative of the potential member, has served or is currently serving in the military, (iii) supplemental service information, (iv) an electronic image of the potential member's face, and (v) at least one name and associated payment information; and
a verification and confirmation server, coupled to the member database and communication port, to:
automatically perform a validation process on the request for military service verification, wherein the validation process does not include a look-up of the name in a service database,
assign a unique identifier to the potential member,
store information about the potential member, including the unique identifier, in the member database, and
arrange for an identification card, including the name, the image of the potential member's face, and the unique identifier, to be provided to the potential member, wherein the potential member is now designated as a verified member.

2. The system of claim 1, further comprising:
receiving, from a first remote partner server of a plurality of remote partner servers each associated with a different partner, a confirmation request including a first identifier to be confirmed;
automatically locating the first identifier in the member database; and
responsive to said locating, transmitting an electronic confirmation request to the first remote partner server.

3. The system of claim 2, wherein the confirmation request is processed via an application programming interface.

4. The system of claim 3, wherein the confirmation request is associated with a benefit bundle program.

5. The system of claim 1, wherein the supplemental service information includes at least one of: (i) service years, (i) rank title, (iii) unit, (iv) pay grade, and (v) branch of service.

6. The system of claim 1, wherein the unique identifier is associated with a travel discount code.

7. The system of claim 1, wherein the verification process is associated with knowledge-based authentication.

8. A computer-implemented method, comprising:
receiving, from a remote potential member device, an electronic message comprising a request for military service verification;
receiving, from the remote potential member device, an indication of an affirmative attestation that the potential member, or a relative of the potential member, has served or is currently serving in the military;
receiving, from the remote potential member device, supplemental service information;
receiving, from the remote potential member device, an electronic image of the potential member's face;
receiving, from the remote potential member device, at least one name and associated payment information;
automatically performing a validation process on the request for military service verification, wherein the validation process does not include a look-up of the name in a service database;
assigning a unique identifier to the potential member;
storing information about the potential member, including the unique identifier, in a member database behind a firewall device; and
arranging for an identification card, including the name, the image of the potential member's face, and the unique identifier, to be provided to the potential member, wherein the potential member is now designated as a verified member.

9. The method of claim 8, further comprising:
receiving, from a first remote partner server of a plurality of remote partner servers each associated with a different partner, a confirmation request including a first identifier to be confirmed;
automatically locating the first identifier in the member database; and
responsive to said locating, transmitting an electronic confirmation request to the first remote partner server.

10. The method of claim 9, wherein the confirmation request is processed via an application programming interface.

11. The method of claim 10, wherein the confirmation request is associated with a benefit bundle program.

12. The method of claim 8, wherein the supplemental service information includes at least one of: (i) service years, (i) rank title, (iii) unit, (iv) pay grade, and (v) branch of service.

13. The method of claim 8, wherein the unique identifier is associated with a travel discount code.

14. The method of claim 8, wherein the verification process is associated with knowledge-based authentication.

15. A non-transitory, computer-readable medium storing instructions that, when executed by a computer processor, cause the computer processor to perform a method, the method comprising:
receiving, from a remote potential member device, an electronic message comprising a request for military service verification;
receiving, from the remote potential member device, an indication of an affirmative attestation that the potential member, or a relative of the potential member, has served or is currently serving in the military;
receiving, from the remote potential member device, supplemental service information;
receiving, from the remote potential member device, an electronic image of the potential member's face;
receiving, from the remote potential member device, at least one name and associated payment information;
automatically performing a validation process on the request for military service verification, wherein the validation process does not include a look-up of the name in a service database;
assigning a unique identifier to the potential member;
storing information about the potential member, including the unique identifier, behind a firewall device; and
arranging for an identification card, including the name, the image of the potential member's face, and the unique identifier, to be provided to the potential member, wherein the potential member is now designated as a verified member.

16. The medium of claim 15, further comprising:
receiving, from a first remote partner server of a plurality of remote partner servers each associated with a different partner, a confirmation request including a first identifier to be confirmed;
automatically locating the first identifier in the member database; and
responsive to said locating, transmitting an electronic confirmation request to the first remote partner server.

17. The medium of claim 16, wherein the confirmation request is processed via an application programming interface.

18. The medium of claim 17, wherein the confirmation request is associated with a benefit bundle program.

19. The medium of claim 15, wherein the supplemental service information includes at least one of: (i) service years, (i) rank title, (iii) unit, (iv) pay grade, and (v) branch of service.

20. The medium of claim 15, wherein the unique identifier is associated with a travel discount code.
